(19) United States
(12) Patent Application Publication
(10) Pub. No.: US 2006/0218602 A1
(43) Pub. Date: Sep. 28, 2006

(54) Replacement of trick mode content in a video on demand system

(76) Inventors: W. Paul Sherer, Danville, CA (US); Kirk Blattman, San Ramon, CA (US); Danny M. Nessett, Fremont, CA (US); David Yates, Menlo Park, CA (US)

Correspondence Address: WILSON & HAM, 2530 BERRYESSA ROAD, PMB: 348, SAN JOSE, CA, 95132, US

(21) Appl. No.: 11/360,079

(22) Filed: Feb. 23, 2006

Related U.S. Application Data
(60) Provisional application No. 60/655,308, filed on Feb. 23, 2005.

(51) Int. Cl. H04N 7/173

(52) U.S. Cl. 725/88

(57) ABSTRACT

A technique for managing video content for a video on demand (VOD) session involves replacing trick mode content with pre-defined replacement content when a trick mode command is executed. The replacement content is displayed in a clear and intelligible manner (e.g., at normal speed) even though a trick mode command, such as fast forward, reverse, or fast reverse, has been executed. In an embodiment, the replacement content is a replacement advertisement, which may be in the form of a moving image that is displayed as normal speed or a fixed image.

### CROSS-REFERENCE TO RELATED APPLICATION

This application is entitled to the benefit of provisional U.S. Patent Application Serial No. 60,655,308, filed Feb. 23, 2005, the disclosure of which is incorporated by reference herein in its entirety.

### FIELD OF THE INVENTION

The invention relates generally to interactive video services via digital video networks, and more particularly to systems and methods for managing video content for video on demand services.

### BACKGROUND OF THE INVENTION

Providers of television-based entertainment are attempting to expand the range of services that they offer to subscribers in order to increase revenues. In addition to television content such as that found on conventional cable networks, some providers also offer interactive video services, such as video on demand (VOD). The provision of interactive video services is stimulating the further development of digital network technology, which in turn will enable providers to increase the number and kinds of video services offered to subscribers.

VOD allows users to select and watch video content over a network as part of an interactive television experience. VOD systems may support “streaming,” in which content is available to the subscriber while the video streams over the network, and/or “downloading,” in which the content is downloaded to a subscriber device, such as a set-top box, before the content is available to the subscriber. VOD systems may also support more advanced functionality such as Network Personal Video Recorder (NPVR). Offering VOD features such as NPVR can increase revenue for video streaming vendors by increasing the attractiveness of their offerings. However, it also allows subscribers to skip over commercials, which attacks another revenue source. Advertisers are reluctant to pay for advertising that subscribers can easily avoid by using NPVR commands, e.g., trick modes.

FIGS. 1A and 1B jointly illustrate one conventional mechanism for organizing program content objects, advertisement content objects, and trick mode objects into a presentation order for a VOD session. FIG. 1A is a schematic representation of a content descriptor 10, according to the prior art. The content descriptor is a data structure that provides a record of object identifiers for program content, advertisement content, and trick mode content. When a VOD server streams a program, it accesses the program content through the content descriptor, which binds the program content, advertisement content, and trick mode content according to a specific presentation order. The content descriptor also includes a reference to an index object that is used by the VOD server to convert content position defined in units of time to content position defined in units of frames.

The content descriptor also includes a reference to a trick mode object. Trick modes are variations of programmatic content that allow the VOD server to implement NPVR functions for a client during a VOD session. Either during ingest or in real-time, the distributed programmatic content is copied and converted to trick mode content objects that display as a fast forward, reverse, or fast reverse version of the program. For example, to implement 4-times (4×) fast forward, an ingest processing element or the VOD server copies the delivered program content to a trick mode object, an omits approximately three (3) out of every four (4) frames. When played at normal speed, the trick mode content object then appears on the display as if it were the program content played at 4 times speed. Other trick mode objects are created similarly.

A content descriptor gathers together all of the information and content necessary to play both program content and advertisement content, as well as to implement NPVR functions on both the program content and the advertisement content. Note that both program segments and advertisement segments are represented by a content descriptor that references index objects and trick mode objects as well as content objects (i.e., program content objects or advertisement content objects). Advertisement trick mode objects are identical in form to program trick mode objects; when played, advertisement trick mode objects display as fast forward, reverse, or fast reverse versions of the normal speed advertisement.

FIG. 1B is a schematic representation of a content descriptor stream 12, also according to the prior art. The content descriptor stream is a data structure that organizes a set of the content descriptors 10 into a presentation order for providing VOD to a client. The presentation order is represented by the order in which the content descriptors appear in the content descriptor stream. As shown in FIG. 1B, the content descriptor stream includes alternating program content segments 14a, 14b, and advertisement content segments 16a, 16b.

Note that the above description with reference to FIGS. 1A-B is a simple explanation for a more complicated conventional process for creating trick mode objects. However, since the exact details of how trick mode objects are created do not affect the invention, a more detailed exposition is not presented here.

FIG. 1C is a block diagram schematically representing a prior art content descriptor 10 for identifying objects which define video content for a VOD session. The content descriptor includes a content object 22, a trick mode content 24, and an index object 26, generally as described above with respect to FIGS. 1A-B. The content object may be a program content object or an advertisement content object; similarly, the trick mode content may be a program trick mode content or an advertisement trick mode content.

In light of the above, what is needed is a system and method for managing video content that allows a VOD system to provide trick mode functionality without completely wiping out the effectiveness of content such as advertising content.

### SUMMARY OF THE INVENTION

A technique for managing video content for a video on demand (VOD) session involves replacing trick mode content with pre-defined replacement content when a trick mode command is executed. The replacement content is displayed in a clear and intelligible manner (e.g., at normal speed) even though a trick mode command, such as fast forward, reverse, or fast reverse, has been executed. In an embodiment, the replacement content is a replacement advertisement, which may be in the form of a fixed image or motion video that appears to be displayed at normal speed. The advantage of providing a replacement advertisement that appears to be displayed at normal speed is that the replacement advertisement is intelligible to the viewer even though the viewer has initiated a trick mode. In contrast, an advertisement that is viewed in trick mode (e.g., in fast forward) may become unintelligible as many of the frames are omitted to achieve the trick mode.

Other aspects and advantages of the invention will become apparent from the following detailed description, taken in conjunction with the accompanying drawings, illustrating by way of example the principles of the invention.

### BRIEF DESCRIPTION OF THE DRAWINGS

FIG. 1A is a schematic representation of a content descriptor, according to the prior art.

FIG. 1B is a schematic representation of a content descriptor stream, according to the prior art.

FIG. 1C is a block diagram schematically representing a prior art content descriptor for defining video content.

FIG. 2A is a schematic representation of an exemplary video on demand system architecture, according to an embodiment of the invention.

FIG. 2B is a block diagram of an exemplary video on demand server, according to an embodiment of the invention.

FIG. 3 is a block diagram schematically representing a replacement content descriptor having at least one replacement content object, according to an embodiment of the invention.

FIG. 4A is a schematic representation of the insertion of a replacement content object into a content descriptor to form a replacement content descriptor, according to an embodiment of the invention.

FIG. 4B is a schematic representation of the insertion of a replacement content object into a content descriptor to form a replacement content descriptor, according to another embodiment of the invention.

FIG. 5 is a flow diagram schematically representing steps involved in an exemplary method for managing video content, according to an embodiment of the invention.

FIG. 6 is a flow diagram schematically representing an exemplary process for managing video content, according to another embodiment of the invention.

Throughout the description, similar reference numbers may be used to identify similar elements.

### DETAILED DESCRIPTION OF THE INVENTION

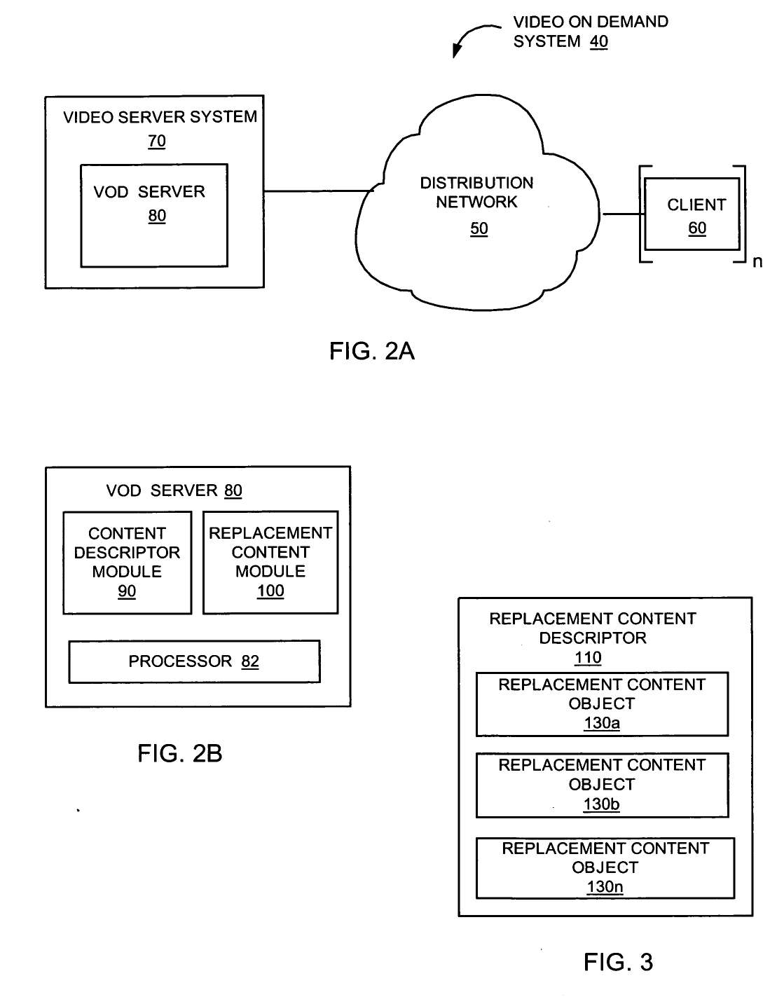

The term “video” as used herein may optionally include audio and/or associated content control information. The term “content” as used herein may be used to refer to digital video content, which may be delivered to a client via a distribution network. A “network” for distributing digital video content may include a packet-based distribution network, wherein the packet-based distribution network may utilize, for example, IP, Ethernet, ATM, or a combination thereof to communicate the digital video content to the client. A “network” for distributing digital video content may also include a hybrid fiber coaxial (HFC) network, as is well known in the field of cable television distribution. As used herein, the term “object” represents a collection of bytes (an equivalent term for the same concept is “file”). For example, when a program content object is played via a VOD system (e.g., FIG. 2A), program content is displayed at a client.

FIG. 2A is a schematic representation of an exemplary video on demand system architecture, according to an embodiment of the invention. The video on demand system 40 includes a distribution network 50 that is capable of both broadcast/multicast and VOD communications. VOD communications may include NPVR functions such as fast forward, reverse, and fast reverse. The distribution network may be implemented with multiple network elements (not separately shown in FIG. 2) for facilitating broadcast/multicast and video on demand communications, as is well known in the art.

As illustrated in FIG. 2A, a video server system 70 is coupled to the distribution network 50. The video server system provides digital video content to multiple clients 60 utilizing a broadcast/multicast scheme over the distribution network. Further, each of the clients is capable of receiving digital video content from the video server system. The video server system includes a VOD server 80 for streaming data streams to clients during a VOD session. The VOD server is configured to provide replacement content to the client. The replacement content may be provided to the client instead of, or in addition to, a trick mode content. The replacement content is provided to the client in response to a command, such as a trick mode command, from the client. The VOD server may also be known as a stream server.

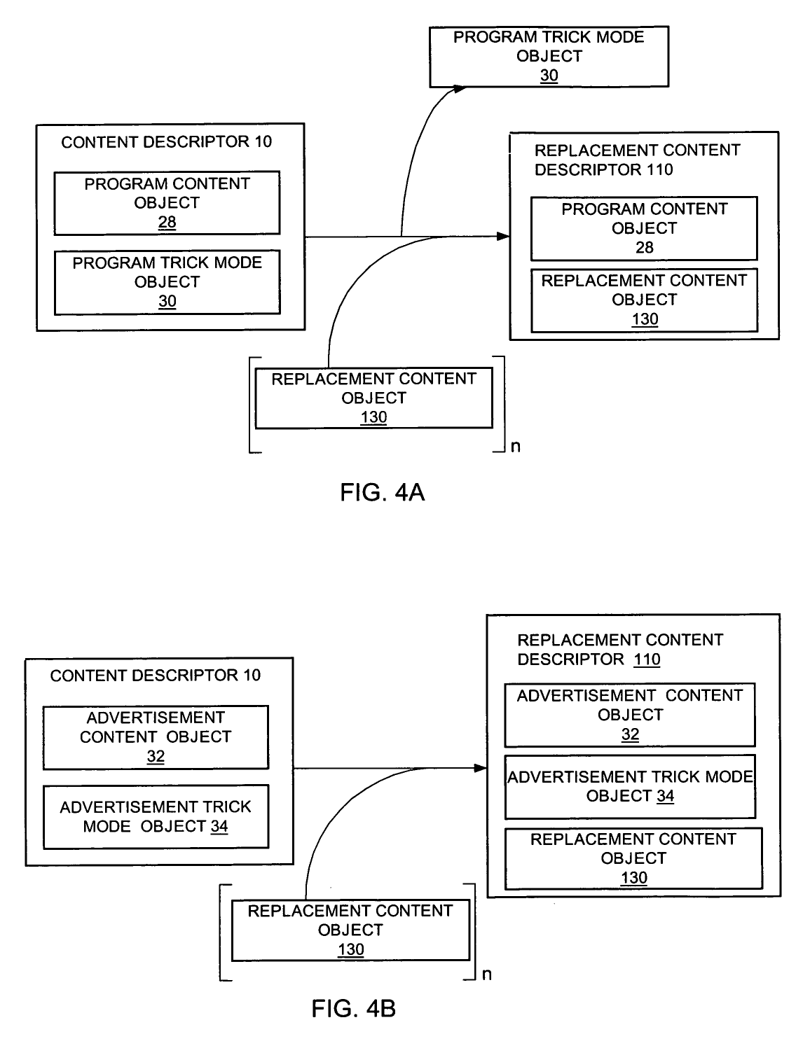

FIG. 2B is a block diagram of an exemplary video on demand server 80, according to an embodiment of the invention. The VOD server includes a processor 82, a content descriptor module 90, and a replacement content module 100. The content descriptor module is configured for providing replacement content descriptors 110 (FIGS. 4A-B), which define video content for VOD. Each replacement content descriptor may include program content objects 28 or advertisement content objects 32 (see FIGS. 4A-B), which play as normal speed program content and normal speed advertisement content segments, respectively.

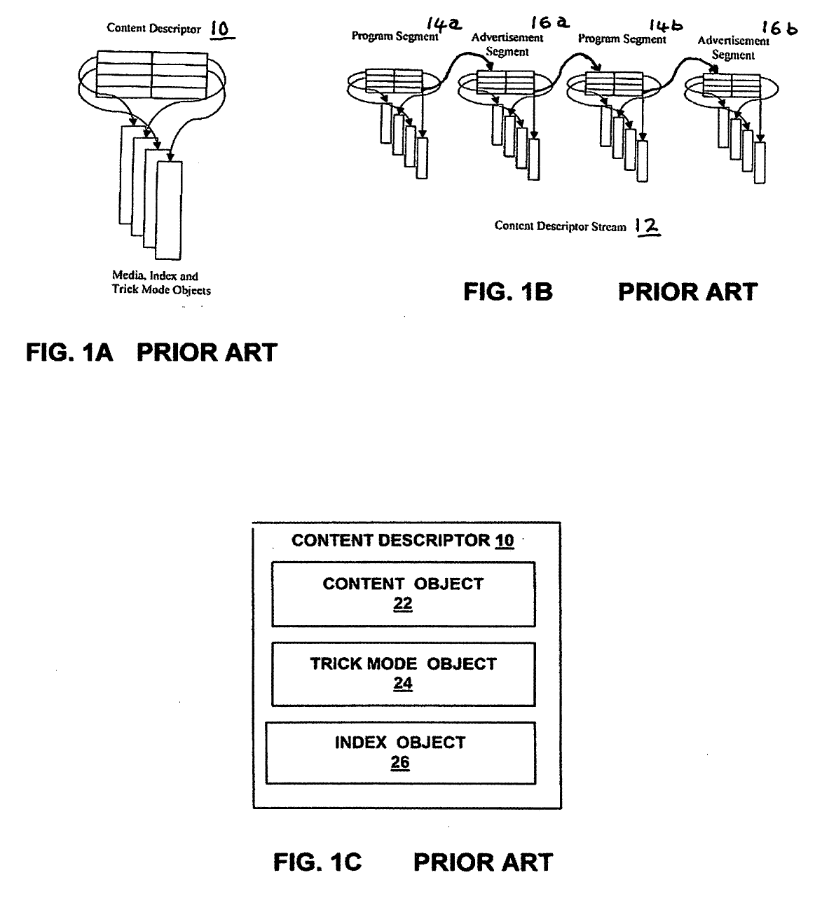

Replacement content descriptors 110 of the invention differ from conventional content descriptors 10 (see, e.g., FIG. 1C) in that the replacement content descriptors have at least one replacement content object 130. According to an embodiment of the invention, the replacement content module 90 inserts at least one replacement content object into a content descriptor provided by the content descriptor module. The replacement content object plays as replacement content, for example, in response to a trick mode command from the client 60. The insertion of replacement content objects into content descriptors to form replacement content descriptors is described in more detail hereinbelow, e.g., with reference to FIGS. 4A-B.

FIG. 3 is a block diagram of a replacement content descriptor 110 according to an embodiment of the invention. The replacement content descriptor includes at least one replacement content object 130. In FIG. 3, the replacement content objects are labeled as 130a, 130b, and 130n. It is to be understood, however, that the invention is not limited to replacement content descriptors having a particular number of replacement content objects. Naturally, each replacement content descriptor may further include various other content objects, such as one or more program content objects 28 and program trick mode objects 30, as shown in FIG. 4A. In some embodiments, the replacement content descriptor may include one or more advertisement content objects 32 and advertisement trick mode objects 34, see, e.g., FIG. 4B.

FIG. 4A schematically represents the insertion of a replacement content object 130 into a content descriptor 10, according to an embodiment of the invention. The content descriptor includes a program content object 28 and a program trick mode object 30. The program content object is configured to play (e.g., displayed on a client monitor/TV screen) as normal speed program content. The program trick mode content is configured to play as trick mode program content, wherein the trick mode may be, for example, fast forward, reverse, or fast reverse. In the scheme of FIG. 4A, the content descriptor may be regarded as a nascent form of the replacement content descriptor 110. The replacement content descriptor is formed when at least one replacement content object is inserted into the content descriptor. The replacement content descriptor may include multiple replacement content objects 130a-n (see FIG. 3). In an embodiment, the program trick mode content may be ejected from the replacement content descriptor before, during, or after, insertion of the replacement content object. Thus, in the embodiment of FIG. 4A, the replacement content descriptor 110 may lack a trick mode content. The replacement content descriptors of FIGS. 4A-B may further include an index object 26 (FIG. 1C); these elements are omitted from FIGS. 4A-B for the sake of clarity.

Although the content descriptor 10 and the replacement content descriptor 110 in FIG. 4A show a program content object 28 and a program trick mode content 30, it is to be understood that an analogous mechanism for forming the replacement content descriptor may be used in the case of a content descriptor having an advertisement content object 32 and an advertisement trick mode content 34.

FIG. 4B is a schematic representation of the insertion of a replacement content object 130 into a content descriptor 10 to form a replacement content descriptor 110, according to another embodiment of the invention. The content descriptor includes an advertisement content object 32 and an advertisement trick mode content 34. The advertisement content object is configured to play (e.g., displayed on a client monitor/TV screen) as normal speed advertisement content. The advertisement trick mode content is configured to play as trick mode advertisement content, wherein the trick mode may be, for example, fast forward, reverse, or fast reverse. In the scheme of FIG. 4B, the content descriptor may again be regarded as a nascent form of the replacement content descriptor. The replacement content descriptor is formed when at least one replacement content object is inserted into the content descriptor. The replacement content descriptor may include multiple replacement content objects 130a-n (see FIG. 3). In contrast to the insertion technique shown in FIG. 4A, in the embodiment of FIG. 4B the at least one replacement content object is added to the constituents of the content descriptor. Thus, in the embodiment of FIG. 4B, the replacement content descriptor may include the replacement content object(s) in addition to a trick mode object (e.g., the advertisement trick mode content, as shown in FIG. 4B).

Although the content descriptor 10 and replacement content descriptor 110 in FIG. 4B show an advertisement content object 32 and an advertisement trick mode content 34, it is to be understood that an analogous mechanism for forming the replacement content descriptor may be used in the case of a content descriptor having a program content object 28 and a program trick mode content 30.

In an embodiment, each replacement content object 130 plays as a normal speed replacement content. Playing of the replacement content object may be triggered by a client-initiated event. As an example, the replacement content object may be played in response to a trick mode command. The trick mode command may be, for example, a fast forward command, a reverse command, or a fast reverse command. In other embodiments, the replacement content object plays as a fixed image replacement content. In some embodiments, the replacement content object may play concurrently, or in concert, with either a program trick mode content 30 or an advertisement trick mode content 34. In an embodiment, the replacement content object inserted in the replacement content descriptor 110 may play such that the replacement content is superimposed on the trick mode content.

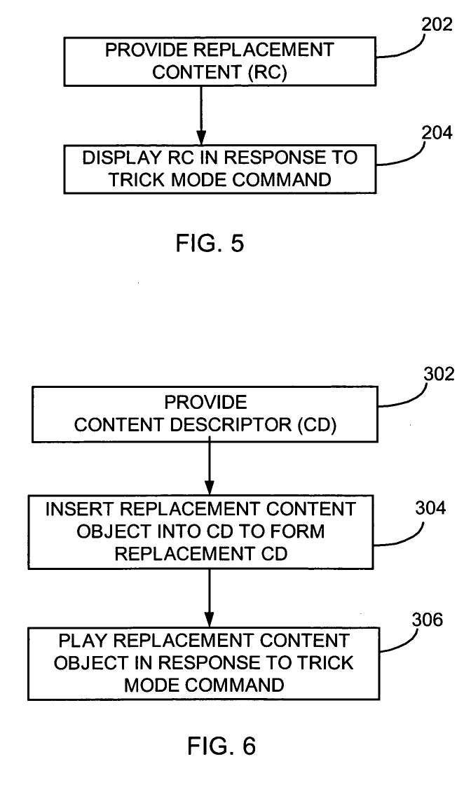

FIG. 5 is a flow diagram schematically representing tasks involved in an exemplary method for managing video content, according to an embodiment of the invention. FIG. 5 will be described in the context of a VOD session which includes NPVR functionality. At block 202, replacement content is provided. The replacement content is transmitted as one or more frames from the VOD server 80 to the client 60. The replacement content may take various forms. The replacement content may include a moving image or a still image. The replacement content may include audio in addition to various images. When the replacement content includes a moving image, the replacement content is streamed as a data stream from the VOD server to the client. When the replacement content includes a still image, the replacement content may be either transmitted as a single frame which is displayed for the duration of the replacement content, or transmitted to the client as a data stream of the same frame which may also be displayed for the duration of the replacement content. In an embodiment, the replacement content is a replacement advertisement, which may be in the form of a moving image that is displayed as normal speed or a fixed image. The advantage of providing a replacement advertisement that appears to be displayed at normal speed is that the replacement advertisement is intelligible to the viewer. This is contrast to an advertisement that may become unintelligible when played out in trick mode.

At block 204, the replacement content may be displayed in response to a trick mode command. The trick mode command may include a command for fast forward, reverse, or fast reverse. The trick mode command may be input via the client 60, e.g., by a subscriber; and the replacement content may be displayed on a client device such as a monitor/display or subscriber TV screen. (Such client devices being well known in the art.)

With further reference to FIG. 5, the replacement content may be displayed at block 204 instead of a trick mode content. As a non-limiting example, if a client 60 gives a trick mode command to fast forward at 8× in an attempt to avoid an advertisement having a duration of 120 seconds at normal speed (1× speed), the replacement content may be displayed to the client for a time period equal to, greater than, or less than 15 seconds (120/8). The replacement content is created such that it is intelligible to the client, for example, as a still image or as motion video playing at normal speed. Absent the invention, i.e., without the replacement content provided by the replacement content object 130 in the replacement content descriptor 110, an unintelligible, 8× moving image would be displayed.

Again with reference to block 204 (FIG. 5), in an embodiment, the replacement content, which may be in the form of a moving or still image, is played in concert with a trick mode content. For example, the replacement content may be superimposed on the trick mode content. The trick mode content may be program trick mode content or advertisement trick mode content. In an embodiment, the replacement content object may include a status indicator, or indicators. For example, a status indicator may be a horizontal time bar that advances or retards at the trick mode rate.

As a non-limiting example of an aspect of the invention, the following scenario is painted. During a VOD session for a baseball game, a trick mode command for fast reverse causes a program trick mode object to be played, such that a program segment is displayed as an unintelligible, fast reverse moving image of the program (baseball game). At the same time (i.e., during −8× trick mode) the replacement content is superimposed, as an intelligible, still or moving image, on top of the fast reverse moving image. As another non-limiting example, the superimposed replacement content may comprise statistics of the baseball game and/or a logo of a commercial organization. In situations where the replacement content comprises statistics of the baseball game, the statistics displayed at a given time may correspond to a stage in the game being displayed as fast reverse trick mode. The time period during which a replacement content is displayed, i.e., the time for which the replacement content object 130 plays, is at least to some extent a matter of design choice. For example, the replacement content may be displayed for a period of time equal to, greater than, or less than the time required to play a trick mode content.

FIG. 6 is a flow diagram schematically representing an exemplary process for managing video content, according to another embodiment of the invention. At block 302, a content descriptor 10 is provided. The content descriptor may be provided by the content descriptor module 90 of the VOD server 80. The content descriptor includes at least one of a program content object 28, an advertisement content object 32, a program trick mode content 30, and an advertisement trick mode content 34 (see, e.g., FIGS. 4A-B). At block 304, at least one replacement content object 130 is inserted into the content descriptor to form the replacement content descriptor 110 (see, e.g., FIGS. 4A-B). In an embodiment, insertion of the at least one replacement content object to form the replacement content descriptor 110 may be accompanied by ejection of one or more trick mode objects (e.g., FIG. 4A). Accordingly, one or more trick mode objects may be substituted by one or more replacement content objects. In another embodiment, insertion of the at least one replacement content object, to form the replacement content descriptor, results in the addition of one or more replacement content objects to one or more program trick mode objects 28 or advertisement trick mode objects 34 (e.g., FIG. 4B), such that the replacement content descriptor includes both trick mode objects and replacement content object(s).

At block 306, the replacement content object 110 is played in response to a trick mode command. The trick mode command may be a client 60 command for fast forward, reverse, or fast reverse. The trick mode command may be given, as an example, by a subscriber's input to a set-top box, e.g., via a remote control. Playing the replacement content object displays a replacement content, for example, at the client's video display or monitor.

The replacement content may take various forms, as described hereinabove, e.g., with respect to FIG. 5. As a non-limiting example, the replacement content may be a replacement advertisement that plays at normal speed, wherein the replacement advertisement is played instead of, or is superimposed on, a trick mode (e.g., a fast forward or fast reverse) version of an original, typically more lengthy, advertisement.

The replacement advertisement may be related to the original advertisement, e.g., the replacement advertisement and the original advertisement may be for the same commercial product/service, or from the same commercial entity or sponsor. Alternatively, the replacement advertisement may be unrelated to the original advertisement, e.g., the replacement advertisement and the original advertisement may be for completely different products/services and/or from unrelated commercial entities.

In an embodiment, a replacement content descriptor 110 may include multiple replacement content objects 130a-n (see FIG. 3), wherein the multiple replacement content objects play as different replacement contents. In which case, a selection may be made from the multiple replacement content objects to define which of the replacement content objects is to be played as replacement content in response to a given trick mode command. In an embodiment, such a selection is made on the basis of sequentially playing each of the multiple replacement content objects, i.e., the multiple replacement content objects may be selected on the basis of a repeating sequence of the multiple replacement content objects. In an alternative embodiment, selection of a replacement content object from the multiple replacement content objects is made on the basis of the state of a VOD server. For example, the selection may be made on the basis of the usage history of each of the multiple replacement content objects. Other mechanisms for selecting from among multiple replacement content objects are also within the scope of the invention, as may be apparent to the skilled artisan in light of the teachings contained herein.

Those skilled in the art will recognize that the invention may be implemented in software, firmware, hardware, or a combination thereof. The above-described embodiments of the invention may also be implemented, for example, by processor-executable instructions. For example, processor-executable instructions may be executed by processor 82 to perform tasks as described with reference to FIG. 5 and FIG. 6. The instructions may reside in various types of computer readable media. Accordingly, another aspect of the present invention concerns a programmed product, comprising computer readable media tangibly embodying a program of machine-readable instructions executable by processor 82 to perform the various techniques and methods in accordance with embodiments of the present invention.

In some embodiments, the computer readable media may comprise, for example, RAM, or a magnetic data storage diskette. The processor-executable instructions may also be stored on a variety of machine readable storage media, such as a DASD storage (e.g., a conventional “hard drive” or a RAID array), magnetic tape, electronic read-only memory, an optical storage device (e.g., content descriptor ROM, WORM, DVD, digital optical tape), paper “punch” cards, or other suitable computer readable media, including transmission media such as digital communication links. In an illustrative embodiment of the invention, the machine-readable instructions may comprise lines of compiled C, C++, or similar language code commonly used by those skilled in the art.]

In some NPVR applications, the term “real time control command” is used instead of the term “trick mode command.” Use of the term “trick mode command” herein can be considered synonymous with the term real time control command. A well-known protocol for controlling real time operations is referred to as the Real Time Streaming Protocol (RTSP).

As used herein, trick modes expressly include fast forward, reverse, and fast reverse, where the fast forward and fast reverse could be at any rate greater than the normal playout rate. VOD as used herein includes the delivery of digital video content via unicasting. VOD my include the downloading of content to a client for future display, the streaming of content to a client for immediate display, and/or NPVR functionality such as fast forward, reverse, and fast reverse of streamed content.

Although specific embodiments of the invention have been described and illustrated, the invention is not to be limited to the specific forms or arrangements of parts as described and illustrated herein. The invention is limited only by the claims.

What is claimed is:

1. A method for managing video content, the method comprising:
a) providing replacement content; and
b) displaying the replacement content in response to a trick mode command.

2. The method of claim 1, further comprising:
c) providing a content descriptor for video on demand content, and
d) inserting a replacement content object into the content descriptor to form a replacement content descriptor.

3. The method of claim 2, wherein step d) comprises removing a trick mode object from the content descriptor.

4. The method of claim 1, wherein:
the replacement content descriptor comprises a trick mode object and a replacement content object, and
the replacement content object is played in response to a trick mode command.

5. The method of claim 4, wherein the trick mode object comprises a program trick mode object or an advertisement trick mode object.

6. The method of claim 4, wherein:
the trick mode object comprises an advertisement trick mode object, and
the replacement content object plays as a replacement advertisement at normal speed.

7. The method of claim 1, wherein step b) comprises displaying the replacement content instead of a trick mode content.

8. The method of claim 1, wherein step b) comprises displaying the replacement content in concert with a trick mode content.

9. The method of claim 1, wherein step b) comprises superimposing the replacement content on a trick mode content.

10. The method of claim 1, wherein the trick mode command comprises one of fast forward, reverse, and fast reverse.

11. The method of claim 1, wherein the replacement content comprises one of a fixed image and a moving image.

12. The method of claim 1, wherein the replacement content comprises a single frame.

13. The method of claim 1, wherein the replacement content comprises a text message.

14. The method of claim 1, wherein the replacement content comprises scrolled text.

15. A method for managing video content, the method comprising:
a) providing a content descriptor for video on demand content;
b) inserting a replacement content object into the content descriptor to form a replacement content descriptor, wherein the replacement content object plays as a replacement content; and
c) in response to a trick mode command, playing the replacement content object.

16. The method of claim 15, wherein step c) comprises playing the replacement content object instead of playing a trick mode object.

17. The method of claim 15, wherein step c) comprises playing the replacement content object in concert with playing a trick mode object.

18. The method of claim 15, wherein:
the content descriptor comprises a trick mode object and a replacement content object,
the trick mode object plays as a trick mode content,
the replacement content object plays as a replacement content, and
step c) comprises playing the replacement content concurrently with playing the trick mode content.

19. The method of claim 15, wherein:
the content descriptor comprises a program trick mode object, and
step b) comprises replacing the program trick mode object with the replacement content object.

20. The method of claim 15, wherein:
the content descriptor comprises an advertisement trick mode object, and
step c) comprises playing the replacement content object as a replacement advertisement.

21. The method of claim 15, wherein the trick mode command comprises at least one of fast forward, reverse, and fast reverse.

22. A computer readable medium, comprising:
processor-executable instructions for managing video content, the processor-executable instructions comprising the steps of:
a) providing a content descriptor for video on demand content;
b) inserting a replacement content object into the content descriptor to form a replacement content descriptor, wherein the replacement content object plays as a replacement content; and
c) playing the replacement content object in response to a trick mode command.

23. The computer readable medium of claim 22, wherein step c) comprises playing the replacement content object instead of a trick mode object.

24. The computer readable medium of claim 22, wherein the trick mode command comprises one of fast forward, reverse, and fast reverse.

25. A video on demand server, comprising:
a replacement content module, wherein:
the replacement content module is configured to provide a replacement content descriptor,
the replacement content descriptor comprises a replacement content object,
the replacement content object plays as replacement content, and
the video on demand server is configured to play the replacement content object in response to a trick mode command from a client.

26. The video on demand server of claim 25, wherein the trick mode command comprises one of fast forward, reverse, and fast reverse.
